(19) United States
(12) Patent Application Publication
(10) Pub. No.: US 2020/0096396 A1
(43) Pub. Date: Mar. 26, 2020

(54) Gas Sensors

(71) Applicant: AMS Sensors UK Limited, Cambridge (GB)

(72) Inventors: Claudio Zuliani, Essex (GB); Richard Henry Hopper, Cambridge (GB); Florin Udrea, Cambridge (GB); Andrea De Luca, Cambridge (GB); James Eilertsen, Zurich (CH)

(21) Appl. No.: 16/143,323

(22) Filed: Sep. 26, 2018

(51) Int. Cl. G01K 7/04

(52) U.S. Cl. CPC G01K 7/04

(57) ABSTRACT

We disclose herein a gas sensor comprising a catalyst material; a temperature detector configured to measure a change in temperature of the catalyst material; and a plurality of electrodes configured to measure the current and/or resistance of the catalytic material. The gas sensor can be formed using CMOS or CMOS-SOI technologies.

### FIELD

The disclosure relates to gas sensors, particularly but not exclusively, to thermoelectric-catalytic gas sensors.

### BACKGROUND

Micro-hotplates in a CMOS platform are demonstrated in US 2017/343500, US 2006/154401, U.S. Pat. Nos. 5,707,148, and 7,338,640. An IR detector formed in a CMOS platform, similar to those of US 2011/174799, U.S. Pat. Nos. 8,552,380, and 9,214,604, is shown in FIG. 1. The IR detector of FIG. 1 includes a semiconductor substrate 5, with a dielectric layer 10 located on the substrate. The substrate 5 is back-etched such that the dielectric layer 10 forms a dielectric membrane over the etched area. The IR detector also has a passivation layer 50, a plasmonic layer 45, thermopile 35, and a diode 55.

Thermo-electro catalytic gas sensors combine a gas catalyst with a temperature-measuring element and a heater element to control catalyst temperature. Thermo-electro catalytic sensors have been demonstrated in US 2010/0221148, JP2016061592, JP 2008275588, US 2013/0209315, and US 2006/0063291. A thermo electro-catalytic gas sensor formed in a CMOS platform is shown in FIG. 2. A catalytic material 25 is formed on the dielectric layer. Any change in temperature due to the presence of the target gas is detected by the thermopile 35. FIG. 3 shows an energy level diagram corresponding to an example reaction in a calorimetric gas sensor, for example the gas sensor of FIG. 2.

Alternatively, resistive gas sensors combine a gas sensing material with a plurality of electrodes. The gas sensing material is a material that changes its resistance and/or capacitance in the presence of the gas to be sensed. Resistive gas sensors are demonstrated in US 2017/026722, US 2011/244585, and EP1293769.

### SUMMARY

According to one aspect of the present disclosure there is provided a gas sensor comprising: a catalytic material; a temperature detector configured to measure a change in temperature of the catalytic material; and a plurality of electrodes configured to measure the current and/or resistance of the catalytic material.

The device of the present disclosure has electrodes to measure the current and/or resistance of the catalyst or catalytic material. These may be an interdigitated electrode array (IDA) beneath the catalyst. The advantage of this configuration is that the sensor will produce a dual output, calorimetric and resistive signals. For instance, at low temperature calorimetric output can be used as a sensor for carbon monoxide or hydrogen while at high temperature the resistive output can be used as sensor for broad range of volatile organic compounds (VOCs).

The catalytic material may comprise a metal oxide (MOX) material, such as tin oxide, tungsten oxide, Alumina oxide, zinc oxide, copper oxide, a combination of those metal oxides, or other metal oxides. In further examples, the catalytic gas sensing material may be un-doped or doped with elements such as platinum (Pt) or palladium (Pd). Alternately the catalytic gas sensing material could be a polymer or a nanomaterial such as carbon nanotubes or metal oxide nanowires.

The plurality of electrodes may form an interdigitated electrode array. Preferably, the interdigitated array may be located underneath the catalytic material. The electrodes may be in direct physical and/or electrical contact with the catalytic material.

The temperature detector may be a thermopile. Alternatively, the temperature detector may be a diode.

The gas sensor may be configured to provide a calorimetric output, and a resistive output. The gas sensor may be configured such that the temperature detector provides the calorimetric output and the plurality of electrodes provides the resistive output. The calorimetric output may be provided at a first temperature, and the resistive output may be provided at a second temperature.

Alternatively, the calorimetric output and the resistive output may be provided at the same temperature. This may be used to deliver a better quantification of the gas concentration, or to provide a method to self-calibrate the device, i.e., drift correction.

For instance, the resistive measurement may provide a reading which may result either from a single gas at a certain concentration, e.g., ethanol, or may also result from the combination of two gases, e.g., acetone and ethanol, in a particular ratio. This uncertainty depends on the fact that the discrimination among VOCs is not typically possible with a single MOx sensor. However, the measurement of the calorimetric output can be used to confirm whether the signal is produced by a single gas or the combination of the two.

It will be appreciated that this also applies to any two gases of different concentrations. The dual output allows two variables (gas concentrations) to be determined from two equations (calorimetric and resistive outputs). An identical MOx signal (resistive output) may be produced by either concentration X of gas 1, or by concentration Y of gas 1+concentration Z of gas 2. The calorimetric output allows discrimination between the two scenarios as the heat generated may be different, in particular if the combustion heat is different. This has the advantage over conventional MOx sensors of using the same sensor footprint to double the number of outputs.

Alternatively, resistive changes may occur due to the changes in the contact between the interdigitated electrodes and the catalytic material, or due to interaction between humidity and the catalytic material. However, these changes would not produce any calorimetric signal since no heat would be generated. Thus, the dual output would provide a compensating method to correct the resistive output and improve on gas concentration quantification.

The gas sensor may further comprise a heater. The heater may be a microheater. Alternatively, the heater may comprise a Peltier heater switchable between two configurations. In a first configuration a current of a first polarity through the heater may produce a heating effect, and in a second configuration a current of a second polarity through the heater may produce a cooling effect, where the first polarity and the second polarity may be opposite polarities. The heater allows the device to be operated at different temperatures such that different gases may be detected or to improve selectivity to a target gas.

The gas sensor may be configured to operate the heater such that at least two different gases are detected at different temperatures. This may be achieved by means of a temperature modulation set-up. Such method may also avoid issues in terms of thermal contribution to the sensor drift due to convection effects arisen from constant heating.

The gas sensor may comprise a plurality of heaters to improve temperature modulation.

The gas sensor may also comprise multiple catalytic materials such that at least two different gases may be detected.

The gas sensor may further comprise: a semiconductor substrate comprising a substrate portion and an etched cavity portion; and a dielectric layer disposed on the substrate, where the dielectric layer may comprise a dielectric membrane area, and where the dielectric membrane area may be adjacent to the etched cavity portion of the substrate.

The temperature detector may comprise a thermopile which comprises a plurality of thermocouples coupled in series, and at least one thermocouple may comprise first and second thermal junctions, and the first thermal junction may be a hot junction and the second thermal junction may be a cold junction, and the hot junction may be located within the dielectric membrane area and the cold junction may be located outside the dielectric membrane area. This allows the hot thermal junction to be thermally isolated from the semiconductor substrate. Advantageously, this configuration increases sensitivity to a target gas.

Alternatively, both junctions of the thermopile may be located inside the dielectric membrane area.

The catalytic material may be formed on the dielectric layer and the area of the catalytic material may extend throughout the entire dielectric membrane area. This improves performance of the sensor up to an optimum threshold area. The area of the catalytic material may extend throughout an area less than or equal to the optimum threshold area. The performance of the sensor decreases as the area of the catalytic material extends beyond the optimum threshold area.

Advantageously, the gas sensor may be formed using CMOS or CMOS-SOI techniques. This allows low cost manufacturing of devices with a small form factor. The gas sensor may be manufactured using CMOS compatible processes.

The term “CMOS compatible process” covers the processing steps used within a CMOS process as well as covers certain processing steps performed separately from the CMOS process, but utilising processing tools usable in the CMOS processing steps.

Complementary metal-oxide-semiconductor (CMOS) technology is used to fabricate integrated circuits. The CMOS term refers to the silicon technology for making integrated circuits. CMOS processes ensure very high accuracy of processing identical transistors (up to billions), high volume manufacturing, very low cost and high reproducibility at different levels (wafer level, wafer to wafer, and lot to lot). CMOS comes with high standards in quality and reliability. Silicon on Insulator (SOI) embodiments can employ a layered silicon-insulator-silicon substrate in place of conventional silicon substrates.

Not all silicon technologies are CMOS technologies. Examples of non-CMOS technologies include: lab technologies (as opposed to foundry technologies), screen printing technologies, bio-technologies as for example those employed in making fluidic channels, MEMS technologies, very high voltage vertical power device technologies, technologies that use materials which are not CMOS compatible, such as gold, platinum or radioactive materials.

The gas sensor may further comprise a reference material, a second temperature detector configured to measure a change in temperature of the reference material; and a plurality of electrodes configured to measure the current and/or resistance of the reference material. The reference material may be a material which mimics the thermo-conductivity properties of the catalytic material without catalyzing any gas reaction. In other words, the reference material may have substantially similar thermo-conductivity properties as the catalytic material, but may be configured to not act a catalyst for a specified gas reaction. Advantageously, the reference structure provides means to compensate for ambient temperature fluctuations.

The gas sensor may further comprise a second catalytic material, a second temperature detector configured to measure a change in temperature of the second catalytic material, and a plurality of electrodes configured to measure the current and/or resistance of the second catalytic material. The second catalytic material may be a different material to the first catalytic material, and may be configured to act as a catalyst for a different gas reaction to the first catalytic material. This allows the sensor to detect two different gases simultaneously.

It will be appreciated that the gas sensor is not limited to one or two sensors, but many sensors may be formed on the same chip. The gas sensor may comprise, for example, four sensors on the same chip. There may be any number of different active sensors, each having a different catalytic material configured to act as a catalyst for a different gas reaction. There may also be any number of reference sensors, each having a reference material. This allows the gas sensor to detect a number of different gases simultaneously.

The gas sensor may further comprise a second temperature detector, and the second temperature may be configured to measure a change in the ambient temperature. The second temperature sensor may comprise a temperature resistive detector or a temperature diode, located on the bulk of the silicon substrate to measure and account for the ambient temperature fluctuations. The second temperature sensor allows ambient temperature fluctuations to be accounted for.

The gas sensor may have a flip-chip configuration. This has the advantage that the electrodes can be closer to an integrated circuit, thereby reducing noise and improving device performance. Furthermore, this allows the thermopile to be closer to the catalytic material, which increases sensitivity of the device.

According to a further aspect of the present disclosure, there is provided a method of manufacturing a gas sensor, the method comprising: forming a plurality of electrodes; forming a temperature detector; and depositing a catalytic material coupled with the plurality of electrodes.

The method may further comprise forming a second temperature detector. This may be formed on the silicon substrate, and be configured to measured ambient temperature fluctuations.

### BRIEF DESCRIPTION OF THE DRAWINGS

Some preferred embodiments of the disclosure will now be disclosed by way of example only and with reference to the accompanying drawings, in which:

FIG. 1 illustrates a gas sensor according to the state-of-the-art;

FIG. 2 illustrates an alternative gas sensor according to the state-of-the-art;

FIG. 3 shows an energy level diagram corresponding to an example reaction in a calorimetric gas sensor;

FIG. 4 illustrates a cross section of a gas sensor according to one embodiment of the present disclosure;

FIG. 5 illustrates a cross section of a gas sensor according to an alternative embodiment of the present disclosure;

FIG. 6 illustrates a cross section of a gas sensor according to an alternative embodiment of the present disclosure;

FIG. 7 illustrates a cross section of a gas sensor which has a flip-chip configuration, according to an alternative embodiment of the present disclosure;

FIG. 8 illustrates a cross section of a gas sensor which has a reference structure, according to an alternative embodiment of the present disclosure;

FIG. 9 illustrates a cross section of a gas sensor with a second temperature detector, according to an alternative embodiment of the present disclosure; and

FIG. 10 illustrates an exemplary flow diagram outlining the manufacturing method of the gas sensor.

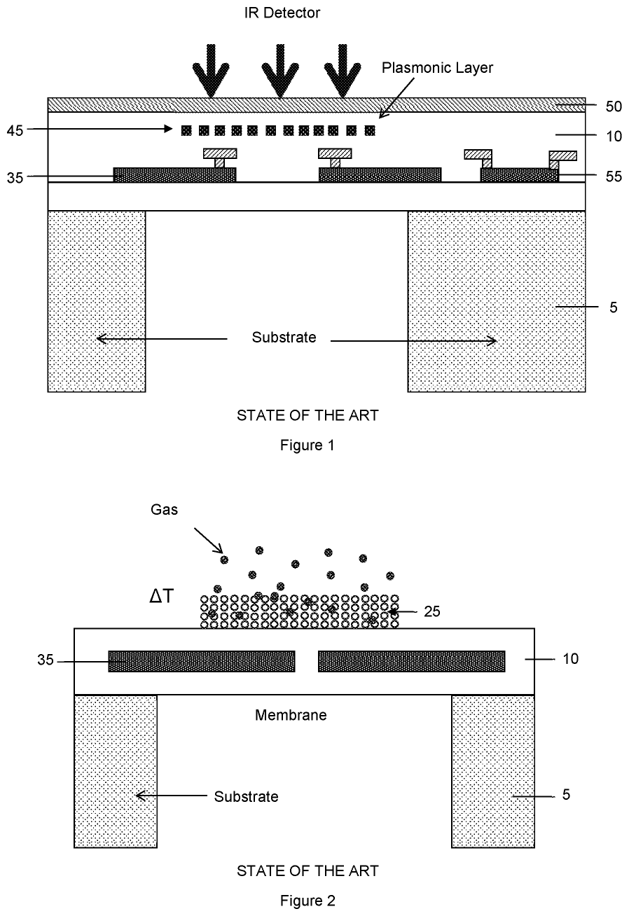

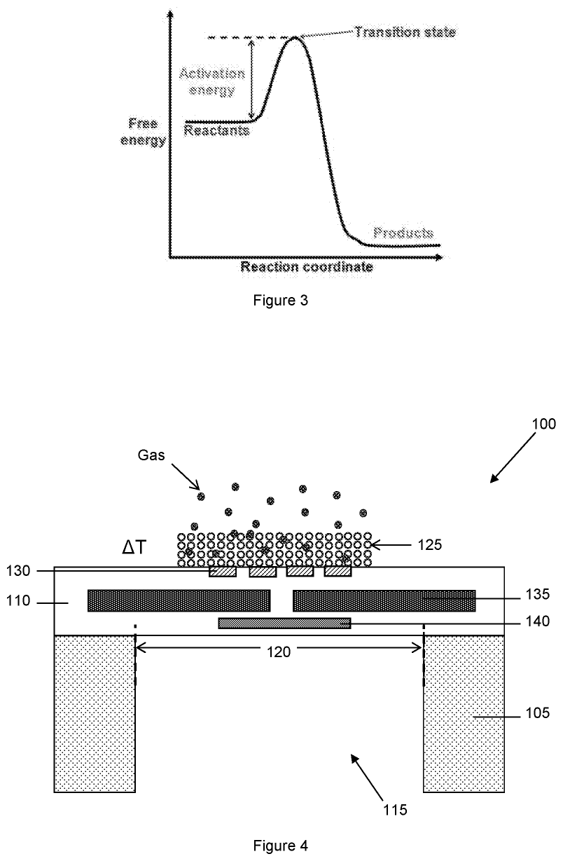

### DETAILED DESCRIPTION

Some examples of the device are given in the accompanying figures.

FIG. 4 shows a cross section of a gas sensor according to one embodiment of the present disclosure. The gas sensor 100 comprises a dielectric layer 110 supported by a semiconductor substrate which has an etched portion 115 and a substrate portion 105. In one example, the semiconductor substrate can be made of silicon or silicon carbide. The dielectric layer 110 has a dielectric membrane region 120, which is located immediately adjacent to or above or over the cavity 115 of the substrate 105. The dielectric layer 110 can be made from a material such as silicon oxide, nitride, or oxinitride. The dielectric membrane area 120 corresponds to the area of the dielectric layer 110 directly above or below the etched portion 115. The substrate is etched by DRIE to form the cavity 115.

A gas sensing catalytic material 125 is deposited or grown on the dielectric membrane 120. Interdigitated electrodes 130 are formed below the catalytic material 125, on or within the dielectric membrane 120. The gas sensing material 125 makes electrical contact to the interdigitated electrodes 130. The electrodes 130 are configured to measure resistance and/or capacitance of the gas sensing material 125. The catalytic gas sensing material 125 is a material that changes its resistance/capacitance in the presence of the gas to be sensed. The membrane structure serves to thermally isolate the gas sensitive layer 125 and heater 140 to significantly reduce the power consumption.

A heater 140 and heater tracks (not shown) are embedded within the dielectric layer 110, which when powered raises the temperature of the gas sensing catalytic layer 125. The heater 140 heats the sensitive layer 125 to a certain temperature used for a chemical or physical reaction to a gas. In this embodiment, the heater 140 is formed within the dielectric membrane area 120 and the heater 140 is a micro-heater and can be made from a metal such as Tungsten, Platinum, or Titanium.

A thermopile 135 is embedded within the dielectric layer 110. The thermopile 135 is configured to measure the heat generated by reactions of analytes on the surface of the dielectric layer 110. The thermopile 135 comprises a number of thermocouples connected in series with their hot junctions (sensing junctions) embedded within a membrane, or other thermally isolating structure, and their cold junctions (reference junctions) located outside the membrane area 120.

The heater 140 can control the temperature of the catalyst 125. This configuration allows a sensor with a dual output. The sensor 100 will produce calorimetric and resistive signals. At low temperatures the sensor 100 acts as a calorimetric sensor and detects gas by measuring the change in temperature using the thermopiles 135. At higher temperatures the sensor 100 acts as a resistive sensor and detects gas by measuring the change in resistance/capacitance of the gas sensing material 125. For instance, at low temperatures, calorimetric output can be used as a selective sensor for carbon monoxide or hydrogen, while at a high temperature the resistive output can be used as a sensor for a broad range of volatile organic compounds.

The microheater may be replaced with a Peltier cooler, heater, or thermoelectric heat pump. This is a solid-state active heat pump which transfers heat from one side of the device to the other, with consumption of electrical energy, depending on the direction of the current. The temperature can be controlled by switching the current polarity to generate either heating or cooling as desired.

FIG. 5 shows a cross section of a gas sensor according to an alternative embodiment of the present disclosure. Many of the features are the same as those shown in FIG. 4 and therefore carry the same reference numerals. In this example, the catalyst 125 extends across the entire area of the dielectric membrane area 120. Having a catalyst 125 substantially (or almost) the same or similar size as the dielectric membrane 120 improves the performance of the device.

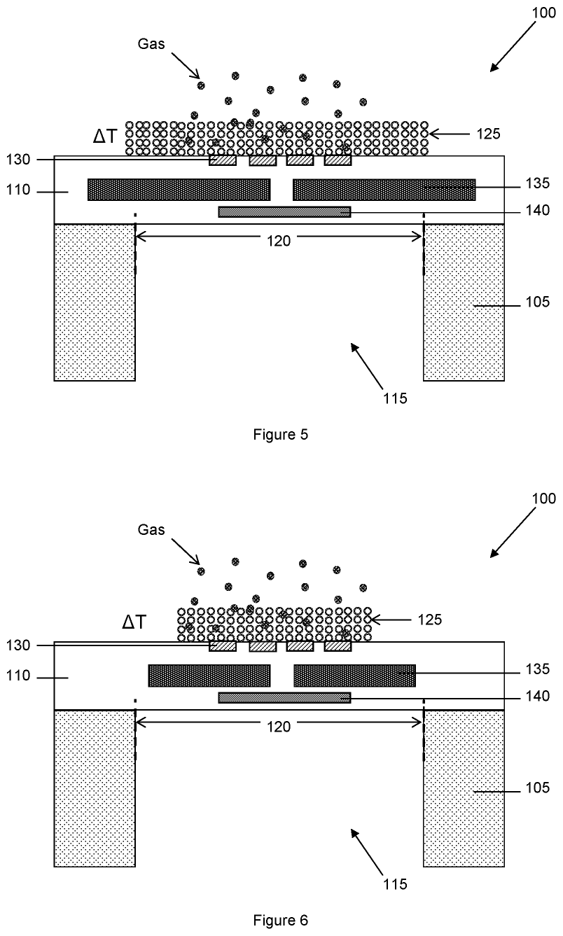

FIG. 6 shows a cross section of a gas sensor according to an alternative embodiment of the present disclosure. Many of the features are the same as those shown in FIG. 4 and therefore carry the same reference numerals. In this embodiment both the hot and cold junctions of the thermopile 135 are formed within the dielectric membrane area 120. This produces a smaller response than having the cold junction outside of the dielectric membrane 120.

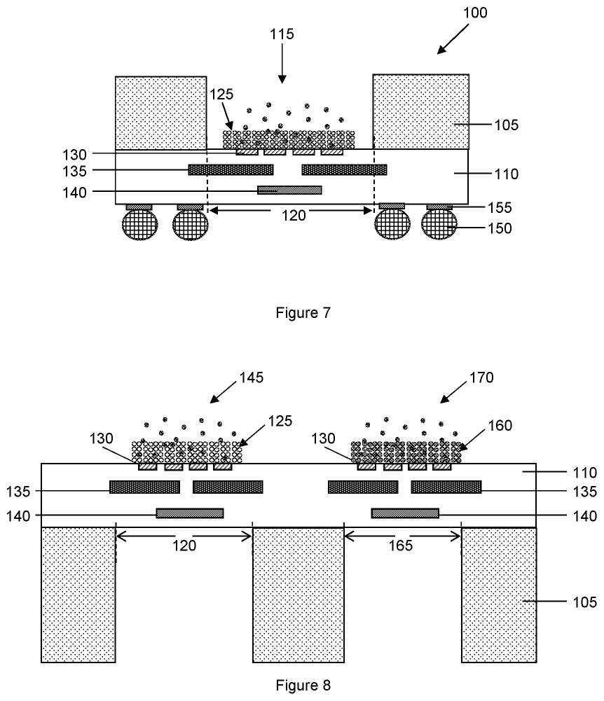

FIG. 7 illustrates a cross section of a gas sensor which has a flip-chip configuration, according to an alternative embodiment of the present disclosure. Many of the features are the same as those shown in FIG. 4 and therefore carry the same reference numerals. The gas sensor 100 is formed in a flip-chip configuration. The gas sensor can be placed above a circuit (e.g. an application specific integrated circuit (ASIC) or printed circuit board (PCB)), using Solder balls, solder bumps, copper pillars, or stud bumps 150 for connection. The solder balls 150 are typically placed on solderable pads, 155, and can be formed within the CMOS process or post-CMOS at wafer level or chip level on both the IR device and the ASIC. This embodiment has the advantage that device can be manufactured such that the thermopile 135 is closer to the circuit, therefore reducing noise and improving device response.

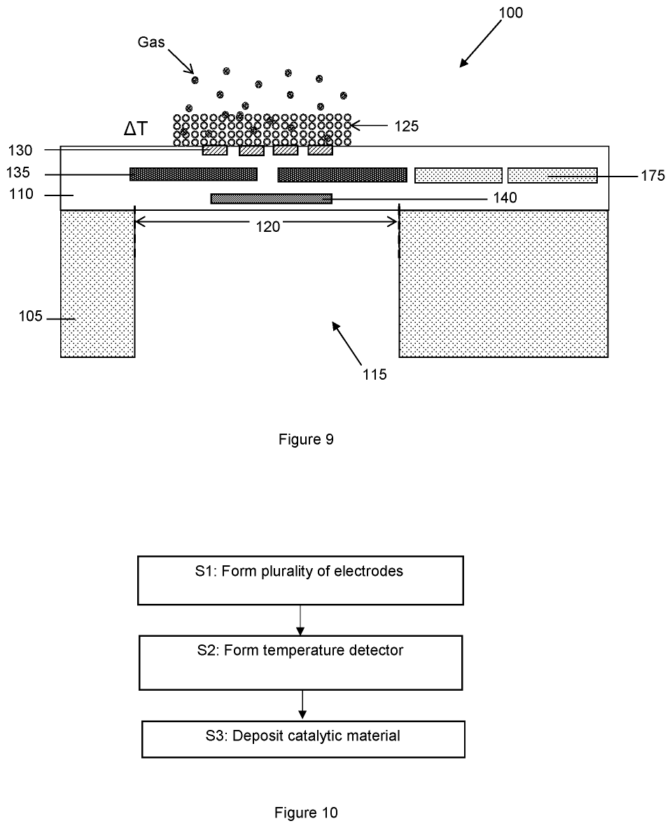

FIG. 8 illustrates a cross section of a gas sensor which has a reference structure 170, according to an alternative embodiment of the present disclosure. Many of the features are the same as those shown in FIG. 4 and therefore carry the same reference numerals. The gas sensing device has a second membrane area 165. Over the second membrane area 165 there is deposited a reference material 160. The reference material is a material which mimics the thermo-conductivity properties of the catalytic material without catalyzing any gas reaction. The reference structure 170 allows compensation for ambient temperature fluctuations.

FIG. 9 illustrates a cross section of a gas sensor with a second temperature detector, according to an alternative embodiment of the present disclosure. Many of the features are the same as those shown in FIG. 4 and therefore carry the same reference numerals. The gas sensing device has a second temperature detector 175, this can be a temperature resistive detector (thermopile) or a temperature diode. This temperature detector 170 is located on the bulk of the silicon substrate 105 to measure and account for the ambient temperature fluctuations.

FIG. 10 illustrates an exemplary flow diagram outlining the manufacturing method of the gas sensor.

In step 1 (S1), a plurality of electrodes are formed.

In step 2 (S2), a temperature detector is formed.

In step 3 (S3), a catalytic, gas sensing material layer is formulated and deposited. The catalytic material may be a paste which is deposited on a device by a dispenser, and then annealed.

The skilled person will understand that in the preceding description and appended claims, positional terms such as ‘top’, ‘bottom’, ‘above’, ‘overlap’, ‘under’, ‘lateral’, etc. are made with reference to conceptual illustrations of a sensor, such as those showing standard cross-sectional perspectives and those shown in the appended drawings. These terms are used for ease of reference but are not intended to be of limiting nature. These terms are therefore to be understood as referring to a device when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1. A gas sensor comprising:
a catalyst material;
a temperature detector configured to measure a change in temperature of the catalyst material; and
a plurality of electrodes configured to measure the current and/or resistance of the catalytic material.

2. A gas sensor according to claim 1, wherein the plurality of electrodes forms an interdigitated electrode array.

3. A gas sensor according to claim 2, wherein the interdigitated array is in contact with the catalytic material.

4. A gas sensor according to claim 1, wherein the temperature detector is a thermopile, or wherein the temperature detector is a temperature diode.

5. A gas sensor according to claim 1, wherein the gas sensor is configured to provide a calorimetric output, and a resistive or capacitive output.

6. A gas sensor according to claim 5, wherein the gas sensor is configured such that the temperature detector provides the calorimetric output and the plurality of electrodes provide the resistive or capacitive output.

7. A gas sensor according to claim 5, wherein the calorimetric output is provided at a first temperature, and the resistive or capacitive output is provided at a second temperature.

8. A gas sensor according to claim 5, wherein the calorimetric output and the resistive output are provided at the same temperature.

9. A gas sensor according to claim 1, further comprising a heater.

10. A gas sensor according to claim 9, wherein the heater is a microheater.

11. A gas sensor according to claim 9, wherein the heater comprises a Peltier heater switchable between two configurations.

12. A gas sensor according to claim 11, wherein in a first configuration a current of a first polarity through the heater produces a heating effect, and wherein in a second configuration a current of a second polarity through the heater produces a cooling effect, and wherein the first polarity and the second polarity are opposite polarities.

13. A gas sensor according to claim 9, wherein the gas sensor is configured to operate the heater such that at least two different gases are detected at different temperatures.

14. A gas sensor according to claim 13, wherein the catalyst material is formed on the dielectric layer and wherein the area of the catalyst material extends throughout the entire dielectric membrane area.

15. A gas sensor according to claim 1, further comprising:
a semiconductor substrate comprising a substrate portion and an etched cavity portion;
a dielectric layer disposed on the substrate, wherein the dielectric layer comprises a dielectric membrane area, wherein the dielectric membrane area is adjacent to the etched cavity portion of the substrate.

16. A gas sensor according to claim 15, wherein the temperature detector comprises a thermopile which comprises a plurality of thermocouples coupled in series, and wherein at least one thermocouple comprises first and second thermal junctions, and wherein the first thermal junction is a hot junction and the second thermal junction is a cold junction, and wherein the hot junction is located within the dielectric membrane area and wherein the cold junction is located outside the dielectric membrane area.

17. A gas sensor according to claim 1, wherein the gas sensor further comprises:
a reference material, wherein the reference material has substantially similar thermo-conductivity properties as the catalytic material, but is configured to not act as a catalyst for a specified gas reaction;
a second temperature detector configured to measure a change in temperature of the reference material; and
a plurality of electrodes configured to measure the current and/or resistance of the reference material.

18. A gas sensor according to claim 1, wherein the gas sensor further comprises:
a second catalytic material, wherein the second catalytic material is a different material to the catalytic material;
a second temperature detector configured to measure a change in temperature of the second catalytic material; and
a plurality of electrodes configured to measure the current and/or resistance of the second catalytic material.

19. A gas sensor according to claim 1, wherein the gas sensor further comprises a second temperature detector, and wherein the second temperature is configured to measure a change in the ambient temperature.

20. A method of manufacturing a gas sensor, the method comprising:
forming a plurality of electrodes;
forming a temperature detector; and
depositing a catalytic material coupled with the plurality of electrodes.
